(19) United States
(12) Patent Application Publication
(10) Pub. No.: US 2007/0117475 A1
(43) Pub. Date: May 24, 2007

(54) Prevention of Sn whisker growth for high reliability electronic devices

(75) Inventor: King-Ning Tu, Los Angeles, CA (US)

Correspondence Address: VENABLE LLP, P.O. BOX 34385, WASHINGTON, DC, 20043-9998, US

(73) Assignee: Regents of the University of California, Oakland, CA (US)

(21) Appl. No.: 11/285,312

(22) Filed: Nov. 23, 2005

(51) Int. Cl. H01R 13/02

(52) U.S. Cl. 439/884

(57) ABSTRACT

An electrical lead for an electronic device has a core conductor and a finishing layer of a Sn alloy deposited on a surface of the core conductor of the electrical lead. The finishing layer of the Sn alloy deposited on the surface of the core conductor is of a chemical composition that hinders the formation of Sn whiskers. An electronic device has such an electrical lead.

### BACKGROUND

1. Field of Invention

The current invention relates to electrical leads having reduced problems with the growth of metal whiskers and electrical devices that use such electrical leads.

2. Discussion of Related Art

Metallic objects have long been known to grow metallic whiskers under certain circumstances. Almost always, the whiskers erupt (grow) from metallic films that are deposited on a substrate material by electroplating. This is known to occur on a variety of substrate metals electroplated with a variety of metals or metal alloys. It has long been known that the use of lead (Pb)-based solders on electrodes, decrease the event of metal whisker growth. However, there is concern with Pb in the environment, as was the case with paints containing Pb and Pb additives in gasoline. There is now a program to eliminate Pb from electronic components including eliminating Pb from solders used in connecting electrical components. Tin (Sn) and tin-copper (SnCu) solders have been used as substitutes for solder that contains lead.

Spontaneous Sn whisker growth is known to occur readily on matte Sn finishes on Cu. A matte Sn finish is an electroplated finish of Sn that is dull in appearance due to the rough surface texture, which in turn is due to the relatively large grain size (typically 5 μm or greater) of the matte Sn. Today, because of the wide-spread applications of Pb-free solder on Cu conductors in the electronic packaging of consumer electronic products, Sn whisker growth has become a serious reliability issue because Pb-free solders are Sn-based. See Ivan Amato, “Tin whiskers: The next Y2K problem,” Fortune magazine, vol. 151, issue 1, p.27 (2005) for a good general description of the problem. In fact, a Sn whisker has killed a Galaxy satellite. The issue currently concerns mainly the Cu leadframes used on surface mount technology of electronic packaging. The leadframes are finished with a layer of eutectic SnCu or pure Sn solder for surface passivation and for enhancing wetting during joining the leadframes to printed circuit boards. Whiskers of Sn are frequently observed on the finishes. Some whiskers can grow to several hundred micrometers, which are long enough to become electrical shorts between neighboring legs of a leadframe.

FIG. 1 of W. J. Choi, T. Y. Lee, K. N. Tu, N. Tamura, R. S. Celestre, A. A. MacDowell, Y. Y, Bong, and L. Nguyen, “Tin whiskers studied by synchrotron radiation micro-diffraction,” Acta Mat., 51 , 6253-6261(2003) is an SEM image of Sn whiskers grown on a eutectic SnCu finished Cu leadframe. Many long Sn whiskers have been found and one of them as shown is long enough to short two neighboring legs of the leadframe. When there is a high electrical field across the narrow gap between the tip of a whisker and the point of contact on the other leg, a spark may ignite a fire around the tip of the whisker touching the other leg. The fire may result in failure of the device, which could even include a whole satellite. See, Ivan Amato, “Tin whiskers: The next Y2K problem,” Fortune magazine, vol. 151, issue 1, p.27 (2005); Rob Spiegel, “Threat of tin whiskers haunts rush to lead-free,” Electronic News, Mar. 17,2005; and http://www.nemi.org/proiects/ese/tin whisker.html for general discussions of the problem of Sn whiskers.

Another mode of failure is a broken whisker falling onto two electrical contacts and bridging them, thus causing a short circuit. Spontaneous whisker growth is a creep process in which both stress generation and stress relaxation occur simultaneously at room temperature. In particular, (1) the room temperature grain boundary diffusion of Sn in Sn, (2) the room temperature reaction between Sn and Cu to form Cu₆Sn₅, which induces the compressive stress in Sn, and (3) a stable and protective surface of Sn oxide have been found to be the three necessary and sufficient conditions for Sn whisker growth on Cu substrates. (See, W, J. Choi, George Galyon, K. N. Tu and T. Y. Lee, “The structure and kinetics of tin whisker formation and growth on high tin content finishes,” Chapter 21in “Handbook of lead-free solder technology for microelectronic assemblies,” edited by K. J. Puttlitz and K. A. Stahel', Marcel Dekker, N.Y. (2004); G. T. T. Sheng, C. F. Hu, W. J. Choi, K. N. Tu, Y. Y. Bong, and L. Nguyen, “Tin whiskers studied by focused ion beam imaging and transmission electron microscopy,” J. Appl. Phys., 92, 64-69(2002); W. J. Choi, T. Y. Lee, K. N. Tu, N. Tamura, R. S. Celestre, A. A. MacDowell, Y. Y, Bong, and L. Nguyen, “Tin whiskers studied by synchrotron radiation micro-diffraction ,” Acta Mat., 51, 6253-6261 (2003), the entire contents of each of which are hereby incorporated by reference.) Whiskers are eruptions on the oxidized surface of the finish. Without the oxide, for example, in an ultra high vacuum, there will be no whisker growth. Above-cited references describe the use of cross-sectional scanning and transmission electron microscopy to examine Sn whiskers, with samples prepared by focused ion beam thinning. Above-cited references also describe the use of x-ray micro-diffraction in synchrotron radiation to study the structure and stress distribution around the root of a whisker grown on eutectic SnCu.

Sheng et al, cited above, observed short whiskers on pure or matte Sn finished surfaces, as shown in FIG. 9 therein. The surface of the whisker in FIG. 9 of Sheng et al is faceted. Besides the difference in morphology, the rate of whisker growth on the pure Sn finish is much slower than that on the SnCu finish. The direction of growth is more random too.

The Cu in eutectic SnCu seems to enhance Sn whisker growth when one compares the whiskers formed on SnCu to those of pure Sn. Although the composition of eutectic SnCu consists of 98.7 atomic % of Sn and 1.3 atomic % of Cu, the small amount of Cu seems to cause a very large effect on whisker growth on the eutectic SnCu finish.

An irregular layer of Cu₆Sn₅ compound has been observed between a Cu core conductor of a leadframe and a SnCu finish layer. The grain size in the SnCu finish was about several microns. More importantly, there were Cu₆Sn₅ precipitates in the grain boundaries of SnCu finished layer. The grain boundary precipitation of Cu₆Sn₅ is the source of stress generation in the SnCu finish. It provides the driving force of spontaneous Sn whisker growth by effectively squeezing the Sn grains. In the case of the interface between matte Sn on Cu, much less grain boundary precipitation of Cu₆Sn₅ was present. This is an important microstructure difference between eutectic SnCu and the matte Sn. The microstructure difference has been observed to be strongly correlated to the size difference of Sn whiskers grown on the finished surfaces.

Currently, the industry solution or the solution recommended by the National Electronics Manufacturing Initiative (NEMI) is to use matte Sn as the surface finish and deposit a Ni layer on the Cu leadframe before the plating of the matte Sn. The Ni layer provides a diffusion barrier to prevent the diffusion of Cu into the matte Sn. Since most of the whiskers on matte Sn are short, they might not be a problem for devices that require low reliability such as cellular phones or other consumer products. This might be sufficient for inexpensive electronic products that do not require high reliability, but data are not currently available to verify this. On the other hand, where high reliability devices are required, such as in military or aerospace applications, the Ni/matte Sn solution is not good enough. This is because solder reacts with Ni and some Ni₃Sn₄ intermetallic compound can form within the matte Sn to generate a compressive stress. Only one whisker is enough to cause a device to fail and each failure could result in the loss of life, cause the failure of a critical mission or cause very costly damage such as in the case of satellites. There is thus a need for electrical leads for electronic devices, and for devices using such leads, that have decreased problems with metal whiskers.

### SUMMARY

An electrical lead for an electronic device according to an embodiment of this invention has a core conductor and a finishing layer of a Sn alloy deposited on a surface of the core conductor of the electrical lead. The finishing layer of the Sn alloy deposited on the surface of the core conductor is of a chemical composition that hinders the formation of Sn whiskers.

An electrical lead for an electronic device according to another embodiment of this invention has a core conductor, a diffusion barrier deposited on a surface of the core conductor and a finishing layer of a Sn alloy deposited on a surface of the diffusion barrier. The finishing layer of the Sn alloy deposited on the diffusion barrier is of a chemical composition that hinders the formation of Sn whiskers.

An electronic device according to another embodiment of this invention has a printed circuit board and an electrical lead connected to the printed circuit board. The electrical lead has a core conductor and a finishing layer of a Sn alloy deposited on a surface of the core conductor of the electrical lead. The electronic device also has an integrated circuit chip connected to the electrical lead. The finishing layer of the Sn alloy deposited on the surface of the core conductor is of a chemical composition that hinders the formation of Sn whiskers.

An electronic device according to another embodiment of this invention has a printed circuit board and an electrical lead connected to the printed circuit board. The electrical lead has a core conductor, a diffusion barrier deposited on a surface of the core conductor and a finishing layer of a Sn alloy deposited on a surface of the diffusion barrier. The electronic device also has an integrated circuit chip connected to the electrical lead. The finishing layer of the Sn alloy deposited on the diffusion barrier is of a chemical composition that hinders the formation of Sn whiskers.

An electrical lead for an electronic device according to another embodiment of this invention has a core conductor and a finishing layer of a second conductor deposited on a surface of the core conductor of the electrical lead. The core conductor has a first metal and the finishing layer of the second conductor is a metallic alloy of a second metal and the first metal in an amount that hinders the formation of whiskers of the second metal.

An off-eutectic solder composition according to another embodiment of this invention has between 1.0 to 3.4 wt. % Ag; from 1.0 to 5 wt. % Cu; and a balance of Sn. The off-eutectic solder composition contains a precipitate of Cu₆Sn₅ in grain boundaries of the solder.

A method of manufacturing an electronic device according to another embodiment of this invention includes connecting a leadframe to a printed circuit board and connecting the leadframe to an integrated circuit chip. The leadframe has a core conductor and a finishing layer of a Sn alloy deposited on a surface of the core conductor. The finishing layer of the Sn alloy deposited on the surface of the core conductor is of a chemical composition that hinders the formation of Sn whiskers.

### BRIEF DESCRIPTION OF THE DRAWINGS

The following drawings provide illustrative examples to help one understand the invention in conjunction with the detailed description. The scope of the invention, defined by the claims, is not limited to these illustrative examples.

FIG. 1 is a schematic illustration of a portion of an electrical lead according to an embodiment of the current invention.

FIG. 2 is a schematic illustration of a portion of an electrical lead according to another embodiment of the current invention.

FIG. 3 is a schematic illustration of an electronic device according to an embodiment of the current invention.

### DETAILED DESCRIPTION

This section describes embodiments of the current invention with particular examples in which Cu is the substrate (core conductor) and a layer of an alloy of Sn and Cu, or an alloy of Sn, silver (Ag) and Cu is deposited either directly on the core conductor, or on an intermediate layer of conductive material. However, the general concepts of the invention are not limited to only the use of these materials, but include other materials for the core conductor as well as the deposited layers. As noted in the Background section, the problem of Sn whiskers growing from finishing layers on Cu leads is of particular current concern in the electronics industry, so such examples are described in particular detail.

To prevent Sn whisker growth, one should remove at least one of the three following conditions of whisker growth: (1) Room temperature grain boundary diffusion of Sn in Sn, (2) Room temperature reaction between Sn and Cu to form Cu₆Sn₅, and (3) Formation of a stable and protective surface of Sn-oxide. If we remove any one or more of them, we should have in principle no whisker growth. In practice, substantially removing any one of them should lead to substantially hindered whisker growth. However, as we found from the synchrotron radiation study, it takes only a very small stress level to grow a Sn whisker. It is thus a difficult problem to prevent Sn whisker growth. The solution recommended by NEMI is to satisfy the condition (2) by preventing the Cu from reacting with Sn. To satisfy the condition (3) is unrealistic since one would have to have no oxide on the surface of the finish and to keep the device in ultra-high vacuum, or at least in an oxygen-free environment, to prevent oxidation. We disclose here to substantially satisfy the condition (1) by blocking the grain boundary diffusion of Sn. Also, we disclose that a combination of the two solutions together to satisfy both conditions (1) and (2) is even better.

To prevent Sn whisker growth, one should uncouple stress generation and stress relaxation. One should remove both stress generation and stress relaxation. Stress generation can be removed by blocking the diffusion of Cu into Sn. The NEMI solution is to stop the diffusion of Cu into Sn by electroplating a layer of Ni between the Cu and Sn solder finish. The Ni serves as a diffusion barrier to prevent the diffusion of Cu into Sn. However, up to now, no solution to prevent stress relaxation has been available. In other words, there has been no teachings regarding preventing the creep process or the diffusion of Sn atoms to the whiskers. We thus disclose here to use another kind of diffusion barrier to stop the diffusion of Sn. Since we should block the diffusion of Sn atoms from substantially every grain of Sn in the finish, it is a non-trivial problem to solve.

According to an embodiment of the current invention, we add several percentage of Cu into the matte Sn or the eutectic SnCu solder to hinder and/or eliminate the formation of Sn whiskers. The Cu concentration in eutectic SnCu is only 0.7 wt. % (or 1.3 atomic %). According to this embodiment of the invention, we add about 5 wt. % of Cu. Cu₆Sn₅ will form as grain boundary precipitates. Although prior studies have indicated that the presence of Cu in eutectic SnCu led to increased problems with the formation of Sn whiskers, the current inventors recognized that a further increase in Cu can lead to reduced problems with Sn whiskers. By adding additional Cu, precipitation of Cu₆Sn₅ is able to form in substantially all grain boundaries so that substantially every grain of Sn will be coated by a layer of Cu₆Sn₅. Thus, the grain boundary coating becomes a diffusion barrier to prevent the Sn atoms from leaving the grain. When there is no diffusion of Sn, there is no growth of Sn whiskers since the supply of Sn is cut.

FIG. 1 is a schematic illustration of a section of an electrical lead 100 according to an embodiment of the current invention. The electrical lead 100 has a core conductor 102 and a finishing layer 104. In this embodiment, the finishing layer 104 is a Sn alloy in this particular example, but the general concepts of the invention are not limited to just Sn alloys deposited on core conductors. For many applications in the electronics industry, the core conductor 102 may be Cu, but the general concepts of the invention are not limited to only this material. In this embodiment, the Sn alloy is an alloy of Sn and Cu in which the Cu is present in a greater percentage than is typically used in the eutectic SnCu solders. The finishing layer 104 may be deposited by electroplating. In particular, good results have been obtained using about 5 wt. % Cu in the Sn alloy. The finishing layer 104 of the Sn alloy comprises a plurality of Sn grains 106, which are all labeled with the same reference numeral in FIG. 1, but in practice may not be identical to each other. The grain boundary region 108 contains precipitates of Cu₆Sn₅. The Cu₆Sn₅ in the grain boundaries 108 tend to form a layer substantially surrounding substantially each of the Sn grains 106, thus providing a diffusion barrier preventing Sn from diffusing out of respective grains. In addition, the SnCu in the grain boundaries 108 may be substantially supersaturated in Cu, thus preventing diffusion of Cu from the core conductor 102 to the finishing layer 104.

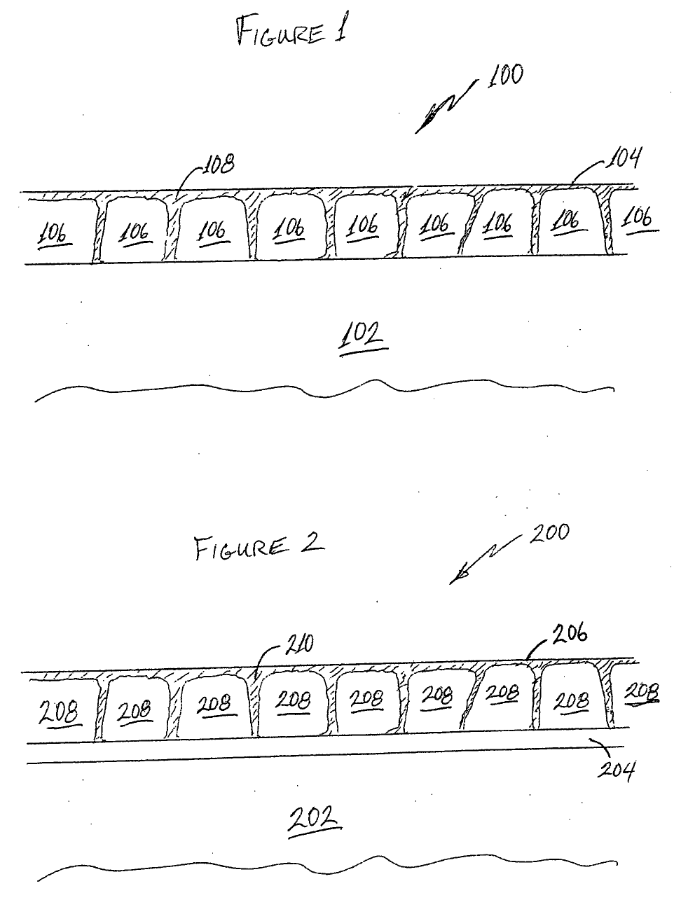

FIG. 2 illustrates an example of another embodiment of a portion of an electrical lead 200 according to the current invention. The electrical lead 200 has a core conductor 202, a diffusion barrier 204 deposited on a surface of the core conductor and a finishing layer 206 deposited on a surface of the diffusion barrier 204. In a particular example, the core conductor 202 may be Cu, the diffusion barrier 204 may be Ni and the finishing layer may be an alloy of Sn that contains Cu. In the schematic illustration of FIG. 2, a plurality of Sn grains 208 are illustrated and are given the same reference numeral for convenience. Each grain is not necessarily identical. Again, the grain boundary 210 contains a precipitate of Cu₆Sn₅ in this example. As noted in the embodiment of FIG. 1, good results have been obtained using a Sn alloy with about 5 wt. % Cu. Again, the general concepts of the invention are not limited to the specific materials shown in this example and are not limited to only the specific concentrations of those materials. The diffusion barrier 204 and finishing layer 206 may each be deposited by electroplating. The diffusion barrier 204 further prevents Cu from core conductor 202 from diffusing into the finishing layer 206. As in the embodiment of FIG. 1, the finishing layer 206 provides both a diffusion barrier that prevents Sn from leaving its respective grain 208 and also prevents Cu from diffusing from the core conductor 202 to the finishing layer 206 due to being substantially supersaturated in Cu.

The general concepts of the invention are not limited to the materials indicated above for the examples shown in FIGS. 1 and 2. Good results have also been obtained using finishing layers in which the Sn alloy contains both Ag and Cu. In particular, good results have been obtained by the current inventor using between 1 to 3.4 wt. % Ag and 1 to 5 wt% Cu with essentially the balance being Sn. The eutectic SnAgCu solder has a composition of about Sn 3.8 Ag 0.7 Cu (in wt. %). The lower concentration of Ag in the range of between 1 to 3.4 wt. % helps to avoid the formation of platelet-like Ag₃Sn in the solder. The Cu in the range of 1 to 5 wt. % helps to prevent the growth of Sn whiskers on the solder surface.

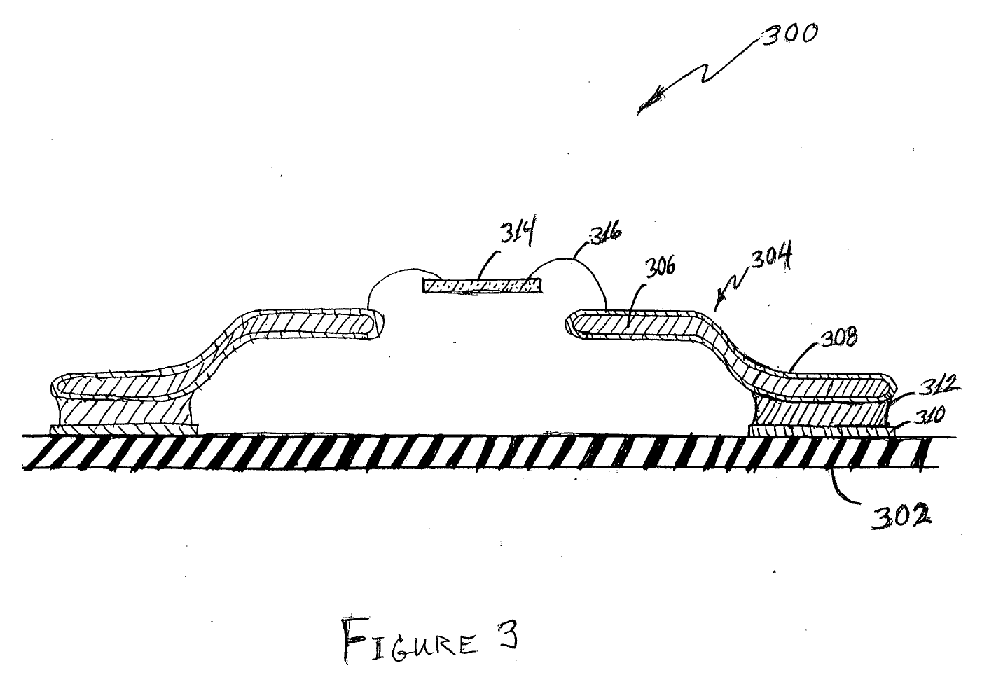

FIG. 3 illustrates a schematic example of an electronic device 300 according to an embodiment of this invention. The electronic device 300 has a printed circuit board 302 in which an electrical lead 304 according to the current invention is connected. The electrical lead 304 may be an electrical lead similar to that of FIG. 1 or of FIG. 2. In FIG. 3, the electrical lead 304 is illustrated to be similar to an electrical lead of FIG. 1 in that no diffusion barrier is illustrated between core conductor 306 and finishing layer 308. However, one may also use in place of lead 304 a lead that includes a diffusion barrier between core conductor 306 and finishing layer 308. The electrical lead 304 is connected to board pad 310 of printed circuit board 302 by surface mount solder 312. An electrical device, such as an integrated circuit chip 314 is electrically connected to the electrical lead 304, for example, by an electrically conductive wire 316. An example of a typical material for the electrically conductive wire 316 is gold, but the invention is not limited to how the electronic device 314 is connected to the electrical lead 304. The right half of FIG. 3 is labeled, and the left half of FIG. 3 may include similar components and are thus not further described as being redundant in this example. In many applications such as that illustrated in FIG. 3, the electrical lead 304 may be a leadframe for an electronic device. However, the general concepts of the invention are not limited to only lead frames.

By selecting Cu instead of another element to form grain boundary precipitates in Sn, the Sn has so much Cu, it will not be able to take more Cu from the leadframe. Also, by adding Cu, the wetting properties of the surface of the finish will be advantageous. This is an important consideration in many applications since without good wetting properties, it should not be used as a finish on the leadframe.

For low reliability devices, it will be sufficient to plate the Sn-5 wt. % Cu directly on Cu leadframes without Ni diffusion barriers. Since the Sn will be substantially supersaturated with Cu, it will not take more Cu from the leadframe. An advantage is that this is a low-cost process without the additional deposition of Ni. For high reliability devices, Ni diffusion barriers may be included along with the Sn-5 wt. % Cu finish on the Ni diffusion barriers. In this combination, diffusion barriers prevent the diffusion of both Cu and Sn. This can be much more effective than just using either one of them alone. Although good results have been obtained using 5 wt. % Cu in SnCu and SnAgCu, this may not be the optimum concentration. As one increases the concentration of Cu over that of eutectic SnCu or eutectic SnAgCu, the effect of diminished Sn whisker growth is achieved. The broad concepts of the invention are not limited to specific materials and concentrations.

Although the current invention was described in terms of specific examples of embodiments of this invention, one of ordinary skill in the art should recognize that numerous alternatives and modifications may be made without departing from the general scope of the invention which is defined by the following claims.

I claim:

1. An electrical lead for an electronic device, comprising:
a core conductor; and
a finishing layer of a Sn alloy deposited on a surface of said core conductor of said electrical lead,
wherein said finishing layer of said Sn alloy deposited on said surface of said core conductor is of a chemical composition that hinders the formation of Sn whiskers.

2. An electrical lead for an electronic device according to claim 1,
wherein said core conductor consists essentially of Cu.

3. An electrical lead for an electronic device according to claim 2, wherein said finishing layer of said Sn alloy further comprises Cu.

4. An electrical lead for an electronic device according to claim 3, wherein said Sn alloy consists essentially of Sn and Cu.

5. An electrical lead for an electronic device according to claim 4, wherein said Sn alloy comprises about 5 wt. % Cu.

6. An electrical lead for an electronic device according to claim 3, wherein said Sn alloy consists essentially of Sn, Ag and Cu.

7. An electrical lead for an electronic device according to claim 6, wherein said Sn alloy comprises from 1 to 5 wt. % Cu and between 1 and 3.4 wt. % Ag.

8. An electrical lead for an electronic device according to claim 2, wherein said finishing layer of said Sn alloy deposited on said surface of said core conductor of said electrical lead is substantially supersaturated with Cu thus hindering migration of Cu from said core conductor to said finishing layer of said Sn alloy.

9. An electrical lead for an electronic device according to claim 4, wherein said Sn alloy comprises Sn grains, each substantially coated by a layer of Cu₆Sn₅ in corresponding grain boundaries, thereby providing a diffusion barrier to prevent Sn atoms from leaving the Sn grains.

10. An electrical lead for an electronic device according to claim 1, wherein said finishing layer of said Sn alloy deposited on said surface of said core conductor of said electrical lead is deposited by electroplating.

11. An electrical lead for an electronic device according to claim 1, wherein said electrical lead is a leadframe for an electronic device.

12. An electrical lead for an electronic device, comprising:
a core conductor;
a diffusion barrier deposited on a surface of said core conductor; and
a finishing layer of a Sn alloy deposited on a surface of said diffusion barrier,
wherein said finishing layer of said Sn alloy deposited on said diffusion barrier is of a chemical composition that hinders the formation of Sn whiskers.

13. An electrical lead for an electronic device according to claim 12, wherein said diffusion barrier prevents atoms from said core conductor from diffusing to said finishing layer of said Sn alloy.

14. An electrical lead for an electronic device according to claim 12, wherein said diffusion barrier consists essentially of Ni.

15. An electrical lead for an electronic device according to claim 12, wherein said diffusion barrier is deposited by electroplating.

16. An electrical lead for an electronic device according to claim 12,
wherein said core conductor consists essentially of Cu.

17. An electrical lead for an electronic device according to claim 16, wherein said finishing layer of said Sn alloy further comprises Cu.

18. An electrical lead for an electronic device according to claim 16, wherein said Sn alloy consists essentially of Sn and Cu.

19. An electrical lead for an electronic device according to claim 18, wherein said Sn alloy comprises about 5 wt. % Cu.

20. An electrical lead for an electronic device according to claim 16, wherein said Sn alloy consists essentially of Sn, Ag and Cu.

21. An electrical lead for an electronic device according to claim 20, wherein said Sn alloy comprises from 1 to 5 wt. % Cu and between 1 and 3.4 wt. % Ag.

22. An electrical lead for an electronic device according to claim 12, wherein said finishing layer of said Sn alloy deposited on said diffusion barrier is substantially supersaturated with Cu thus hindering migration of Cu from said core conductor to said finishing layer of said Sn alloy.

23. An electrical lead for an electronic device according to claim 12, wherein said Sn alloy comprises Sn grains, each substantially coated by a layer of Cu₆Sn₅ in corresponding grain boundaries, thereby providing a diffusion barrier to prevent Sn atoms from leaving the Sn grains.

24. An electrical lead for an electronic device according to claim 12, wherein said finishing layer of said Sn alloy deposited on said diffusion barrier is deposited by electroplating.

25. An electrical lead for an electronic device according to claim 12, wherein said electrical lead is a leadframe for an electronic device.

26. An electronic device, comprising:
a printed circuit board;
an electrical lead connected to the printed circuit board, said electrical lead comprising:
a core conductor; and
a finishing layer of a Sn alloy deposited on a surface of said core conductor of said electrical lead; and
an integrated circuit chip connected to said electrical lead,
wherein said finishing layer of said Sn alloy deposited on said surface of said core conductor is of a chemical composition that hinders the formation of Sn whiskers.

27. An electronic device, comprising:
a printed circuit board;
an electrical lead connected to the printed circuit board, said electrical lead comprising:
a core conductor;
a diffusion barrier deposited on a surface of said core conductor; and
a finishing layer of a Sn alloy deposited on a surface of said diffusion barrier; and
an integrated circuit chip connected to said electrical lead,
wherein said finishing layer of said Sn alloy deposited on said diffusion barrier is of a chemical composition that hinders the formation of Sn whiskers.

28. An electrical lead for an electronic device, comprising:
a core conductor; and
a finishing layer of a second conductor deposited on a surface of said core conductor of said electrical lead,
wherein said core conductor comprises a first metal, and
wherein said finishing layer of said second conductor is a metallic alloy of a second metal that comprises said first metal in an amount that hinders the formation of whiskers of said second metal.

29. An off-eutectic solder composition consisting essentially of:
between 1.0 and 3.4 wt. % Ag;
from 1.0 to 5 wt. % Cu; and
a balance of Sn,
wherein said off-eutectic solder composition contains a precipitate of Cu₆Sn₅ in grain boundaries thereof.

30. A method of manufacturing an electronic device, comprising:
connecting a leadframe to a printed circuit board; and
connecting said leadframe to an integrated circuit chip,
wherein said leadframe comprises a core conductor and a finishing layer of a Sn alloy deposited on a surface of said core conductor, said finishing layer of said Sn alloy deposited on said surface of said core conductor being of a chemical composition that hinders the formation of Sn whiskers.
